(19) United States
(12) Patent Application Publication
(10) Pub. No.: US 2025/0192208 A1
(43) Pub. Date: Jun. 12, 2025

(54) FUEL CELL SYSTEM AND METHOD OF CONTROLLING THE SAME

(71) Applicants: Hyundai Motor Company, Seoul (KR); Kia Corporation, Seoul (KR)

(72) Inventors: Min Gu PARK, Hwaseong-Si (KR); Sang Wook HAN, Seoul (KR)

(73) Assignees: Hyundai Motor Company, Seoul (KR); Kia Corporation, Seoul (KR)

(21) Appl. No.: 18/797,410

(22) Filed: Aug. 7, 2024

(30) Foreign Application Priority Data
Dec. 8, 2023 (KR) 10-2023-0177706

(51) Int. Cl. H01M 8/04746; H01M 8/04119; H01M 8/0438

(52) U.S. Cl. CPC H01M 8/04753; H01M 8/04126; H01M 8/04388; H01M 8/04395; H01M 8/04776

(57) ABSTRACT

A fuel cell system includes a fuel cell stack including an anode and a cathode, an air compressor configured to supply air to the cathode, a hydrogen pressure sensor mounted to an inlet side of the anode, and a controller operatively connected to the air compressor and the hydrogen pressure sensor and configured to determine whether or not compensating for an offset of the hydrogen pressure sensor is necessary and to drive the air compressor and thus open the hydrogen discharge valve when it is necessary to compensate for the offset of the hydrogen pressure sensor.

### CROSS REFERENCE TO RELATED APPLICATION

The present application claims priority to Korean Patent Application No. 10-2023-0177706 filed on Dec. 8, 2023, the entire contents of which is incorporated herein for all purposes by this reference.

### BACKGROUND OF THE PRESENT DISCLOSURE

### Field of the Present Disclosure

The present disclosure relates to a fuel cell system and a method of controlling the fuel cell system.

### DESCRIPTION OF RELATED ART

The fuel cell system is an apparatus which is supplied with hydrogen and air from the outside thereof and generates electrical energy through an electrochemical reaction within a fuel cell stack. The fuel cell system may be used as an electric power source in various fields such as fuel cell electric vehicles (FCEVs) and fuel cells for electric power generation.

A hydrogen pressure sensor for measuring the pressure of the hydrogen supplied to an anode is provided within the fuel cell system. An error (offset) occurs in the hydrogen pressure sensor with the passage of time. Thus, it is necessary to periodically compensate for the offset of the hydrogen pressure sensor.

Generally, when compensating for the offset of the hydrogen pressure sensor, equilibrium is achieved between the pressure of a hydrogen supply system and atmospheric pressure by stopping driving an air compression and opening a hydrogen discharge valve. Then, a measurement value of a hydrogen pressure sensor and a measurement value of atmospheric pressure sensor are compared to obtain a difference therebetween. The offset of the hydrogen pressure sensor is compensated for using the difference.

However, when the hydrogen discharge valve is open to compensate for the offset of the hydrogen pressure sensor, hydrogen present to the anode side of the fuel cell stack is discharged to the outside thereof, passing through the vicinity of an air supply system connected to the hydrogen discharge valve. At the present point, hydrogen discharged to the air supply system may accumulate or may flow backward toward a cathode, adversely affecting the durability of the fuel cell stack. Furthermore, the remaining hydrogen may cause malfunctioning of the fuel cell system. Additionally, the concentration of hydrogen discharged to the outside does not meet the regulations.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell system and a method of controlling the fuel cell system. The system and the method are configured for performing the following operations by driving an air compressor when compensating for an offset of a hydrogen pressure sensor: diluting discharged high-purity hydrogen; minimizing hydrogen discharged from the hydrogen supply system remaining within a fuel cell system; preventing malfunctioning of the fuel cell system when starting the fuel cell system; and preventing a decrease in the durability of a fuel cell stack. Consequently, the system and the method can also meet the regulations.

To accomplish the above-mentioned object, according to one aspect of the present disclosure, there is provided a fuel cell system including: a fuel cell stack including an anode and a cathode; an air compressor configured to supply air to the cathode; a hydrogen pressure sensor mounted to an inlet side of the anode; and a controller operatively connected to the air compressor and the hydrogen pressure sensor and configured to determine whether or not compensating for an offset of the hydrogen pressure sensor is necessary and to drive the air compressor and open a hydrogen discharge valve upon concluding that the compensating for the offset of the hydrogen pressure sensor is necessary.

The fuel cell system may further include: an air pressure sensor mounted to an inlet side of the cathode; and an atmospheric pressure sensor configured for measuring atmospheric pressure, wherein the controller may estimate the pressure of an air outlet in the fuel cell stack based on a measurement value of the air pressure sensor and may compensate for the offset of the hydrogen pressure sensor by comparing a difference between a value of the estimated pressure of the air outlet and a measurement value of the hydrogen pressure sensor with a measurement value of the atmospheric pressure sensor.

In the fuel cell system, the controller may drive the air compressor and may open the hydrogen discharge valve based on the pressure of the hydrogen, measured in the hydrogen pressure sensor.

In the fuel cell system, when a difference between the pressure of the hydrogen, measured in the hydrogen pressure sensor, and the atmospheric pressure is lower than a preset value, the controller may drive the air compressor and may open the hydrogen discharge valve.

In the fuel cell system, the preset value may be determined by a compensation cycle of the hydrogen pressure sensor and the number of offsets occurring per hour in the hydrogen pressure sensor.

In the fuel cell system, the controller may measure an amount of decrease in the pressure of the hydrogen through the hydrogen pressure sensor from the point in time at which the hydrogen discharge valve is open, and may adjust a speed of the air compressor based on the amount of decrease in the pressure of the hydrogen.

In the fuel cell system, the speed of the air compressor may increase in proportion to the amount of decrease in the pressure of the hydrogen.

In the fuel cell system, the hydrogen pressure sensor may include: a first hydrogen pressure sensor; and a second hydrogen pressure sensor, and the pressure of the hydrogen or the amount of decrease in the pressure of the hydrogen, which is measured in the hydrogen pressure sensor, may be an average of measurement values of the first hydrogen pressure sensor and the second hydrogen pressure sensor.

In the fuel cell system, when the offset of the hydrogen pressure sensor is completely compensated for, the controller may stop driving the air compressor and may close the hydrogen discharge valve.

In the fuel cell system, after a preset time elapses, the controller may be configured to determine that it is necessary to compensate for the offset of the hydrogen pressure sensor.

To accomplish the above-mentioned object, according to another aspect of the present disclosure, there is provided a method of controlling a fuel cell system, the method including: determining, by a controller, whether or not compensating for an offset of a hydrogen pressure sensor is necessary; and driving, by the controller, an air compressor and opening a hydrogen discharge valve when compensating for the offset when it is determined that it is necessary to compensate for the offset.

The method, after the driving by the controller of the air compressor and opening of the hydrogen discharge valve, may further include: estimating, by the controller, the pressure of an air outlet in a fuel cell stack based on a measurement value of an air pressure sensor and compensating for the offset of the hydrogen pressure sensor by comparing a difference between a value of the estimated pressure of the air outlet and a measurement value of the hydrogen pressure sensor with a measurement value of an atmospheric pressure sensor.

The method, before the driving by the controller of the air compressor and opening of the hydrogen discharge valve, may further include: determining, by the controller, the point in time at which the air compressor is driven and the hydrogen discharge valve is open, based on the pressure of the hydrogen, measured in the hydrogen pressure sensor.

In the method, the determining by the controller of the point in time at which the air compressor is driven and the hydrogen discharge valve is open may include: receiving, by the controller, the pressure of the hydrogen, measured in the hydrogen pressure sensor; receiving, by the controller, atmospheric pressure, measured in the atmospheric pressure sensor; and determining, by the controller, whether or not a difference between the pressure of the hydrogen, measured in the hydrogen pressure sensor, and the atmospheric pressure, measured in the atmospheric pressure sensor, falls below a preset value.

In the method, in the driving by the controller of the air compressor and the opening of the hydrogen discharge valve, the controller may measure an amount of decrease in the pressure of the hydrogen through the hydrogen pressure sensor and may adjust a speed of the air compressor based on the measured amount of decrease in the pressure of the hydrogen.

The fuel cell system and the method of controlling the fuel cell system can perform the following operations by driving the air compressor when compensating for the offset of the hydrogen pressure sensor: diluting discharged high-purity hydrogen; minimizing hydrogen discharged from the hydrogen supply system remaining within the fuel cell system; preventing malfunctioning of the fuel cell system when starting the fuel cell system; and preventing a decrease in the durability of the fuel cell stack. Consequently, the system and the method can also meet the regulations.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a configuration of a fuel cell system according to various exemplary embodiments of the present disclosure;

FIG. 2 is a view exemplarily illustrating a state where each constituent element operates to compensate for an offset of a hydrogen pressure sensor of the fuel cell system the hydrogen pressure sensor according to the various exemplary embodiments of the present disclosure;

FIG. 3 is a graph showing changes in pressure of an anode and a cathode in a state where the supply of hydrogen and the supply of air are blocked; and

FIG. 4 and FIG. 5 are flowcharts illustrating a method of controlling the fuel cell system according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

For disclosure, various exemplary embodiments of the present disclosure will be described in detail below with reference to the accompanying drawings. The same or similar constituent elements are provided the same reference numeral, and descriptions thereof are not repeated.

In describing the exemplary embodiments of the present disclosure, a detailed description of a well-known technology related thereto will be omitted when determined as making the nature and gist of the present disclosure obfuscated. Furthermore, the accompanying drawings serve only to help easily understand the exemplary embodiments included in the present specification. It should be understood that the technical idea included in the present specification is not limited by the accompanying drawings. Furthermore, it should be understood that any alteration of, any equivalent of, and any substitute for, a constituent element according to an exemplary embodiment of the present disclosure, which fall within the scope of the technical idea of the present disclosure, are included within the scope of the present disclosure.

The terms “first,” “second,” and so on are used to describe various constituent elements that have the same function, but do not impose any limitation on the meanings of these constituent elements. These terms are used only to distinguish among the constituent elements that have the same function.

A noun in singular form has the same meaning as when used in its plural form, unless it has a different meaning in context.

The terms “include,” “have,” and the like in the present application are intended to indicate that a feature, a number, a step, an operation, a constituent element, a component, or a combination of these, which is described in the specification, is present, and thus should be understood not to preclude the possibility that one or more other features, numbers, steps, operations, constituent elements, components, or combinations of these will be present or added.

A controller may include a communication device that communicates with another controller or a sensor to control a function for which the controller is responsible, a memory in which an operating system, logic commands, input and output information, and the like are stored, and one or more processors that perform judgments, computations, determinations, and the like that are necessary to control the function for which the controller is responsible.

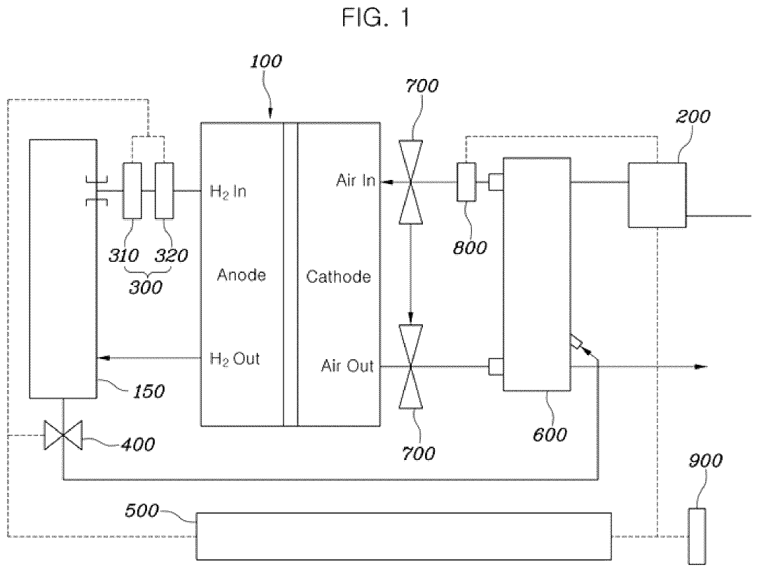

FIG. 1 is a view exemplarily illustrating a configuration of a fuel cell system according to various exemplary embodiments of the present disclosure. The fuel cell system according to the various exemplary embodiments of the present disclosure includes a fuel cell stack 100 that includes an anode and a cathode therein; an air compressor 200 that supplies air to the cathode; a hydrogen pressure sensor 300 which is provided to be positioned to the anode inlet side; and a controller 500 that is configured to determine whether or not it is necessary to compensate for an offset of the hydrogen pressure sensor 300, and when the controller 500 concludes that it is necessary to compensate for the offset of the hydrogen pressure sensor 300, drives the air compressor 200 and thus opens a hydrogen discharge valve (FDV) 400 operatively connected to the controller 500.

Furthermore, the fuel cell system according to the various exemplary embodiments of the present disclosure includes a hydrogen tank 150 that stores hydrogen to be supplied to the fuel cell stack, a humidifier 600 connected to the air compressor 200 and the hydrogen discharge valve 400, an air regulation valve 700 regulates the introduction of air toward the cathode and an air pressure sensor 800 provided to be positioned to the cathode inlet side.

Here, the anode, the hydrogen tank 150, the hydrogen pressure sensor 300 and the hydrogen discharge valve 400 forms a hydrogen supply system, and the cathode, the air compressor 200, the humidifier 600, the air regulation valve 700 and the air pressure sensor 800 forms an air supply system.

Typically, the hydrogen supply system supplying hydrogen toward the anode of the fuel cell stack 100 does not fluidically communicate with the outside thereof. However, in a case where it is necessary to compensate for the offset of the hydrogen pressure sensor 300, the hydrogen discharge valve 400 is open, and the hydrogen discharge valve 400, which is open, is connected to the air supply system, compensating for the offset by exposing the hydrogen pressure sensor 300 to the atmospheric pressure.

However, when compensating for the offset of the hydrogen pressure sensor 300, the concentration of high-purity hydrogen discharged to the outside through the air supply system may exceed the upper discharge concentration limit imposed by the country. Furthermore, hydrogen discharged from the hydrogen supply system may remain in the air supply system, causing malfunctioning of the fuel cell system and thus the degradation of the fuel cell stack 100.

To address these problems, according to an exemplary embodiment of the present disclosure, when compensating for the offset of the hydrogen pressure sensor 300, the hydrogen discharge valve 400 is open, and thus hydrogen is discharged through the air supply system. At the same time, outside air is mixed with the hydrogen discharged from the hydrogen supply system by driving the air compressor 200 and is discharged to the outside of the air supply system. Therefore, the concentration of the discharged hydrogen of the air supply system may be reduced to under the upper discharge concentration limit.

Furthermore, with air pressure formed by the air compressor 200, the hydrogen discharged from the hydrogen supply system remaining in the air supply system can also be readily discharged to the outside of the air supply system. Consequently, the malfunctioning of the fuel cell system due to the remaining hydrogen discharged from the hydrogen supply system and a decrease in the durability of the fuel cell stack due to the flow of the hydrogen discharged from the hydrogen supply system backward to the cathode can also be prevented.

According to an exemplary embodiment of the present disclosure, the hydrogen supply system in use is of an ejector type. When hydrogen is supplied to the anode of the fuel cell stack, the hydrogen discharge valve 400 is closed, blocking connection to the air supply system.

In contrast, in a case where the controller 500 determines that it is necessary to compensate for the offset of the hydrogen pressure sensor 300, the controller 500 may drive the air compressor 200, and at the same time, may open the hydrogen discharge valve 400. When the hydrogen discharge valve 400 is open, the hydrogen supply system fluidically communicates with the air supply system. When the hydrogen discharge valve 400 is open, high-purity hydrogen present in the hydrogen supply system is introduced, along the hydrogen supply system, into the humidifier 600 positioned to the cathode inlet side, and air formed by the air compressor 200 flows to join with the hydrogen discharged from the hydrogen supply system in the humidifier 600 and is discharged into the atmosphere.

At the present point, the air regulation valve 700 that is operatively connected to the controller 500 and regulates the introduction of air toward the cathode is closed. Thus, the air formed by the air compressor 200 all bypasses the cathode without flowing through the cathode, flows into the humidifier 600, mixes with the hydrogen discharged from the hydrogen supply system therein, and is discharged into the atmosphere through an outlet of the humidifier 600.

In the present manner, when compensating for the offset of the hydrogen pressure sensor 300, the concentration of the hydrogen discharged from the hydrogen supply system may be reduced by driving the air compressor 200.

However, when the air compressor 200 is driven to compensate for the offset of the hydrogen pressure sensor 300, the flow of air formed by the driving of the air compressor 200 has an influence on the hydrogen pressure sensor 300. Because of this, the controller 500 is required to use additional logic to determine the offset occurring in the hydrogen pressure sensor 300.

Offset computation logic necessary to compensate for the offset of the hydrogen pressure sensor 300 is described below with reference to FIG. 1.

The fuel cell system according to the various exemplary embodiments of the present disclosure may further include the air pressure sensor 800 which is provided to be positioned to the cathode inlet side, and an atmospheric pressure sensor 900 which is configured for measuring atmospheric pressure. The air pressure sensor 800 is provided to be positioned between the cathode and the humidifier 600, that is, to be positioned to the cathode inlet side and can measure the pressure at which humidified air is introduced into the cathode. As described below, a measurement value of the air pressure sensor 800 is used to estimate the pressure of an air outlet in the fuel cell stack 100.

The atmospheric pressure sensor 900 is provided within the fuel cell system and measures atmospheric pressure. A measurement value of the atmospheric pressure sensor 900 is used to compensate for the offset of the hydrogen pressure sensor 300.

When the air compressor 200 is driven and the hydrogen discharge valve 400 is open to compensate for the offset of the hydrogen pressure sensor 300, the controller 500 receives the measurement value of the air pressure sensor 800 operatively connected to the controller 500. The controller 500 estimates the pressure of the air outlet in the fuel cell stack 100 based on the measurement value of the air pressure sensor 800.

The pressure of the air outlet in the fuel cell stack 100 refers to the pressure of discharged air at the front end portion of the humidifier 600 in front of the air regulation valve 700. The pressure of the air outlet in the fuel cell stack 100 may be estimated as follows:

$${P}_{stkout} = {P}_{skin} - {C}_{d} * ( Re ) * ( \frac{{m}_{stkin}^{2}}{{ρ}_{stkin}} )$$

Pₛₜₖₒᵤₜ: Estimated value of the pressure of an air outlet in a fuel cell stack,
Pₛₜₖᵢₙ: Measurement value of an air pressure sensor,
C_{d}: Discharge coefficient, a ratio between the theoretical mass of air introduced in the cathode without losses for which Bernoulli's theorem can be applied and the actual mass of air introduced in the cathode,
Re: Reynolds number,
mₛₖₜᵢₙ²: Mass of air introduced in a cathode, and
ρₛₜₖᵢₙ: Density of air introduced in a cathode

The controller 500 determines an estimated value Pₛₜₖₒᵤₜ of the pressure of the air output in the fuel cell stack 100 from the above equation. Thereafter, the controller 500 may compute a difference value between the measurement value Pₛₜₖᵢₙ of the hydrogen pressure sensor 300 and the estimated value Pₛₜₖₒᵤₜ of the pressure of the air output in the fuel cell stack 100 and may compute the amount of the offset by comparing the computed difference value and the measurement value of the atmospheric pressure sensor 900.

For example, it is assumed that the pressure of the air outlet is 500 kPa and that the estimated value Pₛₜₖₒᵤₜ of the pressure of the air outlet in the fuel cell stack 100, the measurement value of the hydrogen pressure sensor 300, and the measurement value of the atmospheric pressure sensor 900 are computed as 300 kPa, 450 kPa, and 100 kPa, respectively. There is a difference of kPa between the measurement value of the hydrogen pressure sensor 300 and the estimated value Pₛₜₖₒᵤₜ of the pressure of the air outlet of the fuel cell stack 100. Comparison of the difference of kPa and the measurement value of 100 kPa of the atmospheric pressure sensor 900 indicates that an offset of 50 kPa occurs in the hydrogen pressure sensor 300.

That is, since the hydrogen discharge valve 400 is currently open, the reading of the hydrogen pressure sensor 300 indicates the measurement value of the pressure of the air outlet and the atmospheric pressure. Therefore, the atmospheric pressure measured in the hydrogen pressure sensor 300 is computed by subtracting the pressure of the air output, which is estimated in the hydrogen pressure sensor 300, from the measurement value of the pressure of the air outlet. Accordingly, the comparison of the atmospheric pressure measured in the hydrogen pressure sensor 300 and the pressure measured in the atmospheric pressure sensor 900 can determine the degree to which the offset occurs in the hydrogen pressure sensor 300.

The controller 500 may compensate for only the offset that occurs in the hydrogen pressure sensor 300.

According to the need to compensate for the offset of the hydrogen pressure sensor 300, the controller 500 may immediately open the hydrogen discharge valve 400 and may drive the air compressor 200. However, in a case where the hydrogen discharge valve 400 is open in a state where a significant amount of hydrogen is present in the hydrogen supply system, there may occur the risk of not satisfying discharge concentration regulations because high-concentration hydrogen has to be diluted.

To address the present problem, the fuel cell system according to the various exemplary embodiments of the present disclosure may be configured to determine a point in time at which the hydrogen discharge valve 400 is open and a point in time at which the air compressor 200 is driven.

The controller 500 may be configured to determine the point in time at which the hydrogen discharge valve 400 is open and the point in time at which the air compressor 200 is driven, based on the measurement value of the hydrogen pressure sensor 300, that is, on the pressure of the hydrogen which is measured in the hydrogen pressure sensor 300.

According to the determination of the need to compensate for the offset of the hydrogen pressure sensor 300, the driving of the air compressor 200 is interrupted and the air regulation valve 700 is closed. When this is done, hydrogen present in the anode crosses over toward the cathode. Considering the present phenomenon, at the point in time at which the hydrogen present in the anode completely crosses over toward the cathode, the air compressor 200 starts to be driven, and the hydrogen discharge valve 400 starts to be open. When this is done, a relatively low concentration of hydrogen is present to the anode side. Relatively low-concentration hydrogen is present to the anode side, and the flow of air is formed to dilute the present hydrogen. Consequently, the risk of not satisfying the discharge concentration regulations may be relatively reduced.

The point in time at which the hydrogen discharge valve 400 is open and the point in time at which the air compressor 200 is driven may be determined as a point in time at which a difference between the pressure of the hydrogen, measured in the hydrogen pressure sensor 300, and the atmospheric pressure falls below a preset value.

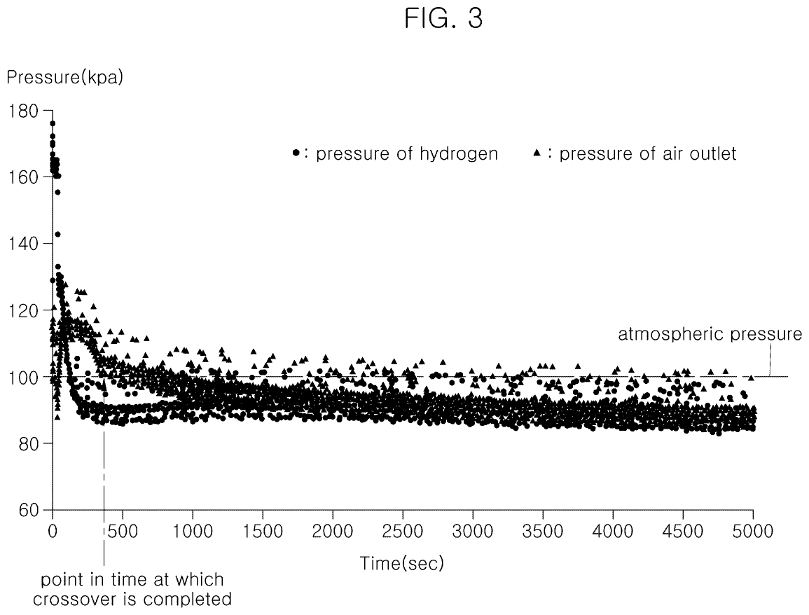

FIG. 3 is a graph showing changes in pressure of the anode and the cathode in a state where the supply of hydrogen and the supply of air are blocked.

From FIG. 3, it may be seen that, as hydrogen flows from the anode to the cathode, the pressure of the anode decreases and the pressure of the cathode increases, and then equilibrium is achieved between the pressure of the anode and the pressure of the cathode. A point in time at which equilibrium is achieved between the pressure of the anode and the pressure of the cathode, or a point in time at which equilibrium is achieved between the pressure of the anode and the atmospheric pressure may be regarded as a point in time at which a crossover is completed. In the instant case, from FIG. 3, it may be seen that the pressure of the anode is constantly maintained.

The point in time at which the hydrogen discharge valve 400 is open and the point in time at which the air compressor 200 is driven may be determined based on these trends in the changes in the pressure of the anode and the pressure of the cathode. The point in time at which the crossover is completed may be determined as the point in time at which the hydrogen discharge valve 400 is open and the point in time at which the air compressor 200 is driven.

According to an exemplary embodiment of the present disclosure, it is assumed that an offset occurs in the hydrogen pressure sensor 300 according to the usage time thereof. Therefore, even at the point in time at which the crossover is completed, the measurement value of the hydrogen pressure sensor 300 may still be practically higher than the atmospheric pressure.

Accordingly, the controller 500 may obtain the point in time at which the crossover is completed, by comparing a value, obtained by subtracting the measurement value of the atmospheric pressure sensor 900 from the measurement value of the hydrogen pressure sensor 300, and a preset value. The preset value here may be determined by a compensation cycle of the hydrogen pressure sensor 300 and the number of offsets occurring per hour that varies according to the specifications of the hydrogen pressure sensor 300. The number of offsets occurring per hour can vary according to the specifications or operating environment of a fuel cell.

For example, the preset value may be determined as follows:
Compensation cycle of a hydrogen pressure sensor: 500 hr,
Number of offsets occurring per hour of a hydrogen pressure sensor: 0.05 kPa/hr, and
Compensation cycle of a hydrogen pressure sensor×the number of occurring offsets=25 kPa
Therefore, the preset value is set to 25 kPa.

The above example assumes that an offset occurs in the hydrogen pressure sensor 300 after the previous offset compensation is performed. Because of this, the controller 500 may be configured to determine a point in time, at which a difference value between the measurement value of the hydrogen pressure sensor 300 and the measurement of the atmospheric pressure sensor 900 falls below 25 kPa, as the point in time at which the crossover is completed. Furthermore, the controller 500 may be configured to determine the point in time at which the crossover is completed, as the point in time at which the hydrogen discharge valve 400 is open and the point in time at which the air compressor 200 is driven.

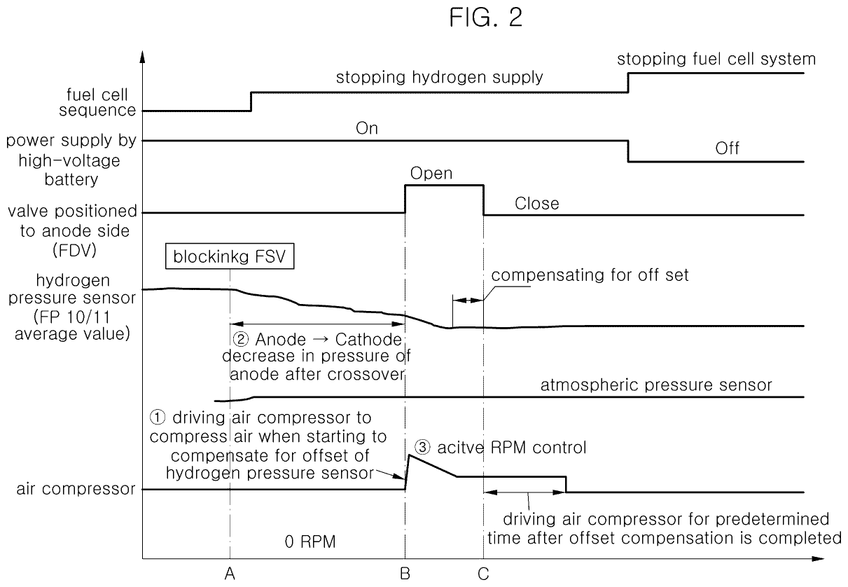

With reference again to FIG. 2, in a case where the controller 500 determines that it is necessary to compensate for the offset of the hydrogen pressure sensor 300, the controller 500 blocks a hydrogen supply valve (FSV) (point in time A). While the pressure of the hydrogen, measured in the hydrogen pressure sensor 300, is continuously monitored, the moment when a difference for the measurement value of the atmospheric pressure sensor 900 falls below a preset value (point in time B), the controller 500 is configured to determine that the crossover of hydrogen present to the anode side to the cathode side is completed, opens the hydrogen discharge valve 400, and starts to drive the air compressor 200.

When the offset of the hydrogen pressure sensor 300 is completely compensated for (point in time C), the controller 500 closes the hydrogen discharge valve 400, drives the air compressor 200 for a preset time to maximally discharge hydrogen present within a pipe to the outside and then stops driving the air compressor 200.

Since the fuel cell not generates electric power, the air compressor 200 and the like are driven by electric power supplied by a high-voltage battery.

According to the present logic, the concentration of hydrogen discharged when compensating for the offset of the hydrogen pressure sensor 300 may be minimized by minimizing hydrogen remaining in the anode and the hydrogen supply system. Accordingly, this can reduce the risk that the hydrogen discharged from the hydrogen supply system will exceed the upper regulated concentration limit.

To achieve a state of equilibrium where the pressure of the anode equals the atmospheric pressure, the remaining hydrogen has to be discharged. However, when high-concentration hydrogen is immediately discharged, various risks are present. Because of this, hydrogen has to be discharged in a state of being sufficiently diluted with air. Therefore, in a case where the concentration of hydrogen to be discharged is high during the present process, it is necessary to further dilute the hydrogen discharged from the hydrogen supply system by increasing airflow. In a case where the concentration of hydrogen to be discharged is low, the air compressor 200 is less driven. That is, the controller 500 may adjust the speed of the air compressor 200 through the amount of decrease in the pressure of the hydrogen which is measured by the hydrogen pressure sensor 300 after the hydrogen discharge valve 400 is open.

The controller 500 measures the amount of decrease in the pressure of the hydrogen through the hydrogen pressure sensor 300 from the point in time at which the hydrogen discharge valve 400 is open. When the amount of decrease in the pressure of the hydrogen is measured, the air compressor 200 may be driven at a speed that corresponds to the measured amount. The reason for this is to further dilute the hydrogen discharged from the hydrogen supply system by increasing an amount of air supplied because an amount of hydrogen discharged is as large as the amount of decrease in the pressure of the hydrogen.

The speed of the air compressor 200 that corresponds to the amount of decrease in the pressure of the hydrogen may be determined according to a data map stored in the controller 500.

With reference to FIG. 2, from point in time B, the controller 500 is configured to control the air compressor 200 so that it starts to be driven. In a case where the amount of decrease in the pressure of the hydrogen is large, the controller 500 is configured to control the air compressor 200 to increase its speed. The controller 500 is configured to control the air compressor 200 so that as the amount of decrease in the pressure of the hydrogen gradually decreases, its speed gradually decreases.

In the fuel cell system, to satisfy an output required of the fuel cell stack 100, hydrogen is required to be stored at a high pressure and to be supplied at an exact rate of flow and at a precise pressure. Because of this, the measurement of the pressure of the hydrogen has a significant influence on the performance and reliability of the fuel cell system.

Accordingly, for the fuel cell system, a plurality of hydrogen pressure sensors are used rather than one hydrogen pressure sensor. According to the various exemplary embodiments of the present disclosure, the hydrogen pressure sensor may include a first hydrogen pressure sensor 310 and a second hydrogen pressure sensor 320.

The pressure of the hydrogen, measured in the above-described the hydrogen pressure sensor 300, may refer to the average of measurement values of the first hydrogen pressure sensor 310 and the second hydrogen pressure sensor 320. Furthermore, the above-described amount of decrease in the pressure of the hydrogen, measured in the hydrogen pressure sensor 300, may refer to the average of amounts of decrease, measured in the first hydrogen pressure sensor 310 and the second hydrogen pressure sensor 320.

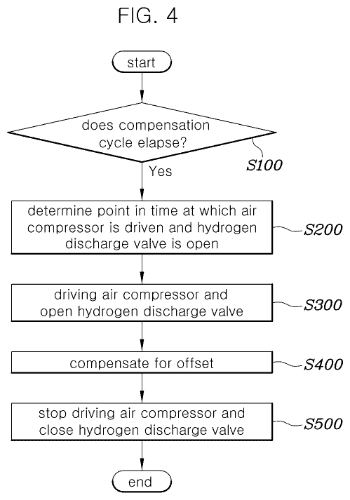

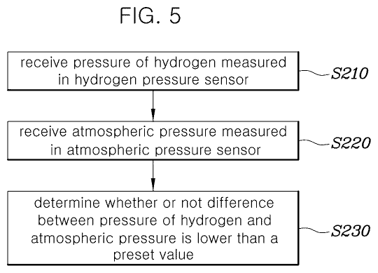

FIG. 4 and FIG. 5 are flowcharts illustrating a method of controlling the fuel cell system according to the various exemplary embodiments of the present disclosure.

The method of controlling the fuel cell system according to the various exemplary embodiments of the present disclosure includes Step S100 of determining, by the controller 500, whether or not it is necessary to compensate for an offset set of the hydrogen pressure sensor 300; and Step S300 of driving, by the controller 500, the air compressor 200 and thus opening the hydrogen discharge valve 400 when compensating for the offset in a case where the controller 500 concludes that it is determined that it is necessary to compensate for the offset.

In Step S100 of determining, by the controller 500, whether or not it is necessary to compensate for the offset of the hydrogen pressure sensor 300, the controller 500 may be configured to determine whether or not it is necessary to compensate for the offset of the hydrogen pressure sensor 300, depending on whether or not a compensation cycle for the offset of the hydrogen pressure sensor 300 elapses.

In a case where the controller 500 determines that the compensation cycle for the offset elapses, to compensate for the offset of the hydrogen pressure sensor 300, the controller 500 may drive the air compressor 200 and thus may open the hydrogen discharge valve 400.

After Step S300 of driving, by the controller 500, the air compressor 200 and opening the hydrogen discharge valve 400, the method of controlling the fuel cell system may include Step S400. In Step S400, controller 500 estimates the pressure of an air inlet in the fuel cell stack 100 based on a measurement value of the air pressure sensor 800 and compensates for the offset of the hydrogen pressure sensor 300 by comparing a difference between a value of the estimated pressure of the air inlet and a measurement value of the hydrogen pressure sensor 300 and a measurement value of the atmospheric pressure sensor 900.

In Step S400 of compensating, by the controller 500, for the offset of the hydrogen pressure sensor, the controller 500, as described above, may estimate the pressure of the inlet pressure in the fuel cell stack 100 based on the measurement value of the air pressure sensor 800. Accordingly, when the controller 500 computes the estimated value of the air outlet in the fuel cell stack 100, the controller 500 may compute the difference between the measurement value of the hydrogen pressure sensor 300 and a value of the estimated pressure of the air outlet in the fuel cell stack 100 and may compute the degree of the offset by comparing a value of the computed difference and the measurement value of the atmospheric pressure sensor 900. That is, the pressure of the air outlet in the fuel cell stack 100 may be estimated as follows:

$${P}_{stkout} = {P}_{skin} - {C}_{d} * ( Re ) * ( \frac{{m}_{stkin}^{2}}{{ρ}_{stkin}} )$$

Pₛₜₖₒᵤₜ: Estimated value of the pressure of an air outlet in a fuel cell stack
Pₛₜₖᵢₙ: Measurement value of an air pressure sensor
C_{d}: Discharge coefficient
Re: Reynolds number
mₛₖₜᵢₙ²: Mass of air introduced in a cathode
ρₛₜₖᵢₙ: Density of air introduced in a cathode

Before Step S300 of driving, by the controller 500, the air compressor 200 and opening the hydrogen discharge valve 400, the method of controlling the fuel cell system may further include Step S200. In Step S200, the controller 500 is configured to determine the point in time at which the air compressor 200 is driven and the hydrogen discharge valve 400 is open, based on the pressure of the hydrogen, measured in the hydrogen pressure sensor 300.

Step S200 of determining, by the controller 500, the point in time at which the air compressor 200 is driven and the hydrogen discharge valve 400 is open may include: S210 of receiving, by the controller 500, the pressure of the hydrogen, measured in the hydrogen pressure sensor 300; Step S220 of receiving, by the controller 500, the atmospheric pressure, measured in the atmospheric pressure sensor 900; and Step S230 of determining, by the controller 500, whether or not a difference between the pressure measured in the hydrogen pressure sensor 300 and the atmospheric pressure falls below a preset value.

That is, as described above, the controller 500 may be configured to determine the point in time at which the air compressor 200 is driven and the hydrogen discharge valve 400 is open, by determining the point in time at which hydrogen completely crosses over the cathode from the anode, and may drive the air compressor 200 and thus open the hydrogen discharge valve 400.

In Step S300 of driving, by the controller 500, the air compressor 200 and opening the hydrogen discharge valve 400, the controller 500 may measure the amount of decrease in the pressure of the hydrogen through the hydrogen pressure sensor 300 for a preset time from the point in time at which the hydrogen discharge valve 400 is open, and may adjust the speed of the air compressor 200 based on the amount of decrease in the pressure of the hydrogen.

In Step S500, the controller 500 may stop driving of the air compressor 200 and close the hydrogen discharge valve 400 after Step S400 of compensating.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell system comprising:
a fuel cell stack including an anode and a cathode;
an air compressor configured to supply air to the cathode;
a hydrogen discharge valve connected to a hydrogen supply system supplying a hydrogen to the anode of the fuel cell stack;
a hydrogen pressure sensor mounted to an inlet side of the anode; and
a controller operatively connected to the air compressor and the hydrogen pressure sensor and configured to determine whether or not compensating for an offset of the hydrogen pressure sensor is necessary and to drive the air compressor and open the hydrogen discharge valve upon concluding that the compensating for the offset of the hydrogen pressure sensor is necessary.

2. The fuel cell system of claim 1, further including:
an air pressure sensor mounted to an inlet side of the cathode; and
an atmospheric pressure sensor configured for measuring atmospheric pressure,
wherein the controller is further configured for estimating a pressure of an air outlet in the fuel cell stack based on a measurement value of the air pressure sensor and to compensate for the offset of the hydrogen pressure sensor by comparing a difference between a value of the estimated pressure of the air outlet and a measurement value of the hydrogen pressure sensor with a measurement value of the atmospheric pressure sensor.

3. The fuel cell system of claim 1, wherein the controller is further configured to drive the air compressor and to open the hydrogen discharge valve based on a pressure of the hydrogen, measured in the hydrogen pressure sensor.

4. The fuel cell system of claim 3, wherein, in response that a difference between a pressure of the hydrogen, measured in the hydrogen pressure sensor, and the atmospheric pressure is lower than a preset value, the controller is further configured to drive the air compressor and open the hydrogen discharge valve.

5. The fuel cell system of claim 4, wherein the preset value is determined by a compensation cycle of the hydrogen pressure sensor and a number of offsets occurring per hour in the hydrogen pressure sensor.

6. The fuel cell system of claim 1, wherein the controller is further configured for measuring an amount of decrease in a pressure of the hydrogen through the hydrogen pressure sensor from a point in time at which the hydrogen discharge valve is open, and for adjusting a speed of the air compressor based on the amount of decrease in the pressure of the hydrogen.

7. The fuel cell system of claim 6, wherein the speed of the air compressor is adjusted to increase in proportion to the amount of decrease in the pressure of the hydrogen.

8. The fuel cell system of claim 1, wherein the hydrogen pressure sensor includes:
a first hydrogen pressure sensor; and
a second hydrogen pressure sensor,
wherein a pressure of the hydrogen or an amount of decrease in the pressure of the hydrogen, which is measured in the hydrogen pressure sensor, is an average of measurement values of the first hydrogen pressure sensor and the second hydrogen pressure sensor.

9. The fuel cell system of claim 2, wherein the hydrogen pressure sensor includes:
a first hydrogen pressure sensor; and
a second hydrogen pressure sensor,
wherein a pressure of the hydrogen or an amount of decrease in the pressure of the hydrogen, which is measured in the hydrogen pressure sensor, is an average of measurement values of the first hydrogen pressure sensor and the second hydrogen pressure sensor.

10. The fuel cell system of claim 6, wherein the hydrogen pressure sensor includes:
a first hydrogen pressure sensor; and
a second hydrogen pressure sensor,
wherein the pressure of the hydrogen or the amount of decrease in the pressure of the hydrogen, which is measured in the hydrogen pressure sensor, is an average of measurement values of the first hydrogen pressure sensor and the second hydrogen pressure sensor.

11. The fuel cell system of claim 1, wherein in response that the offset of the hydrogen pressure sensor is completely compensated for, the controller is further configured to stop driving the air compressor and close the hydrogen discharge valve.

12. The fuel cell system of claim 1, wherein after a preset time elapses, the controller is further configured to determine that the compensating for the offset of the hydrogen pressure sensor is necessary.

13. The fuel cell system of claim 1, further including:
a humidifier connected to the hydrogen discharge valve and the air compressor;
a first air regulation valve connected between an inlet of the cathode and an outlet of the humidifier;
a second air regulation valve connected between an outlet of the cathode and an inlet of the humidifier,
wherein in response that the controller concludes that the compensating for the offset of the hydrogen pressure sensor is necessary, the controller closes the air regulation valve.

14. A method of controlling a fuel cell system, the method comprising:
determining, by a controller, whether or not compensating for an offset of a hydrogen pressure sensor of the fuel cell system is necessary; and
driving, by the controller, an air compressor of the fuel cell system and opening a hydrogen discharge valve of the fuel cell system in response that the controller concludes that the compensating for the offset is necessary.

15. The method of claim 14, further including:
after the driving, by the controller, of the air compressor and the opening of the hydrogen discharge valve,
estimating, by the controller, a pressure of an air outlet in a fuel cell stack based on a measurement value of an air pressure sensor and compensating for the offset of the hydrogen pressure sensor by comparing a difference between a value of the estimated pressure of the air outlet and a measurement value of the hydrogen pressure sensor with a measurement value of an atmospheric pressure sensor.

16. The method of claim 14, further including:
before the driving, by the controller, of the air compressor and the opening of the hydrogen discharge valve,
determining, by the controller, a point in time at which the air compressor is driven and the hydrogen discharge valve is open, based on a pressure of a hydrogen in the fuel cell system, measured in the hydrogen pressure sensor.

17. The method of claim 16, wherein the determining, by the controller, of the point in time at which the air compressor is driven and the hydrogen discharge valve is open includes:
receiving, by the controller, the pressure of the hydrogen, measured in the hydrogen pressure sensor;
receiving, by the controller, atmospheric pressure measured in the atmospheric pressure sensor; and
determining, by the controller, whether or not a difference between the pressure of the hydrogen, measured in the hydrogen pressure sensor, and the atmospheric pressure, measured in the atmospheric pressure sensor, is lower than a preset value.

18. The method of claim 14, wherein, in the driving, by the controller, of the air compressor and the opening of the hydrogen discharge valve, the controller is configured for measuring an amount of decrease in the pressure of the hydrogen through the hydrogen pressure sensor and for adjusting a speed of the air compressor based on the measured amount of decrease in the pressure of the hydrogen.

19. The method of claim 18, wherein the speed of the air compressor is adjusted to increase in proportion to the amount of decrease in the pressure of the hydrogen.
